(19) United States
(12) Patent Application Publication
(10) Pub. No.: US 2004/0174287 A1
(43) Pub. Date: Sep. 9, 2004

(54) Self-contained switch

(76) Inventor: David G. Deak, Brooklyn, NY (US)

Correspondence Address: Allan Chan & Associates, 140 Broadway 46th Floor, New York, NY, 10005, US

(21) Appl. No.: 10/718,308

(22) Filed: Nov. 20, 2003

Related U.S. Application Data
(60) Provisional application No. 60/427,687, filed on Nov. 21, 2002.

(51) Int. Cl. H04L 17/02; G08C 19/00

(52) U.S. Cl. 341/173; 340/825.72

(57) ABSTRACT

The instant invention provides a self-contained switch wherein an energy generating means that is either electromagnetic or piezoelectric, supplies power to the switch and to the circuitry so that the switch can control other appliances on a remote control switch.

### FIELD OF THE INVENTION

This patent application is related to and claims priority from the Provisional U.S. patent application Ser. No. 60/427,687 by Deak filed on Nov. 21, 2002. Therefore, the present invention appertains generally to switches and more specifically to a remote switch that produces its own power.

### BACKGROUND OF THE INVENTION

There are many switches and sensors, which remotely operate a variety of electrical devices. One of the best-known remote control switches is the familiar type that actuates the opening of a garage door. The ubiquitous garage door opener utilizes a battery, usually a 9-volt type, a specific coded frequency, a transmitter, a receiver, and the opening or lifting mechanism in communication with the receiver.

In the consumer electric market there is a well-known chain that sells a remote controlled switch that utilizes batteries to power a transmitter that turns lights and appliances “on” and “off”. Probably, the best-known remote controlled device is the remote television control. Notwithstanding the end purpose, remote control devices have a common requirement, and that is a battery or other power source, so that the switch device is in the powered on condition. A television remote usually utilizes batteries, to generate an infrared signal, and is programmed to transmit information to a decoder that actuates various features of the television set, including the on/off function. However, the problem with most indoor devices is that they tend to be bulky, utilize a power source of one sort or another, and may actuate other remote controlled appliances.

The use of batteries or a hard-wired assemblage stands as the greatest impediment to free use of remote controlled devices. Therefore, there has been a longstanding need to evolve a system that will function independent of a power source yielding a remote controlled device without batteries. One possible source would be a solar-charged battery, but given charging parameters and compromised electrical output, this possibility is impractical.

Therefore, there has been a longstanding need for a switch assembly that would utilize a means to generate the power necessary to operate the switch and its functions. Moreover, if one obviates the need for a battery or other power source, then one can use the switch in a multitude of alternate uses. For example, once there is no power source or battery, one can use the switch as a retrofit, or for new construction and instead of “running wires” within walls and ceiling to light fixtures, to wall switches only wiring the fixture is necessary. In fact, the actual switch may be placed anywhere within the room, or may be spontaneously placed and moved to suit the user.

The wireless industry has enjoyed rapid growth over the past decade and a half. Advances in integrated circuit technology coupled with novel system level solutions have combined to give rise to small, low cost, low power and portable units for a host of wireless communication systems from cell phones to handheld personal data apparatuses. The technology is still constrained by the use of batteries.

For example, the low cost paging receiver is a prime example of this marriage. The radio frequency and analog portions of these devices consume a mere 1.5 mW-5 mW. Indoor wireless systems have also benefited from advancements in integrated circuit technology. The realization of high speed adaptive equalizer, beam-forming and FFT (Fast Fourier Transform) based ASICs for OFDM (orthogonal frequency division multiplexing) based systems are ideal for realizing the physical layer of most high speed wireless indoor links. At high rates even the MAC (medium access control) layer functionality is typically assigned to an ASIC. Again, batteries are the power source.

A cell phone is a low power radio transmitter and receiver. When switched on and actuated by dialing, it sends radio signals that are detected by nearby cellular transmitters and receivers. Funneled through a network the signals are sent and received over a local cell. The over-riding issue is the battery, which supplies electricity to the cell phone, and requires frequent charging.

Another technology has caused a rapid acceleration of wireless technology. Termed, complimentary metal oxide semiconductor (CMOS) technology Complementary Metal Oxide Semiconductor (CMOS) technology is by far one of the most important IC processing technologies available. The suitability and cost effectiveness of CMOS technology for the design and development of digital circuits has helped accelerate the advancement and maturity of this technology. With the exception of very high speed specialized digital circuits, CMOS is the technology of choice for all digital circuits. In fact, the rapid pace of development in this technology coupled with its cost-effectiveness arrived at partly through the economies of scale has made CMOS the technology of choice for analog circuit design as well.

The tremendous advances in CMOS processing technology have shown no sign of slowing down. The current commercially available minimum size channel length is 0.25 microns (micro-meters), compared to the 2.0 micron state of the art technology that was available in 1983. This allows for higher operational frequencies thereby leading the way for present day low cost, low power, highly sophisticated transmitters and receivers on a chip such, as Texas Instruments TRF6900 transceiver chip capable of operating in a range of 850 to 950 MHz ism band (Industrial/scientific/medical).

The high-speed data entry and transfer of this technology along with its low power consumption provides the background for a novel system dedicated to the transmitting and receiving of information over short distances in the range of 50 or 60 meters maximum. Indoor wireless applications include wireless keyboards, mouse devices, remote controls for television, stereos and garage doors, and toys. They all have a common denominator in that they all consume low power amounts; are low cost items, portable, and are wireless, remote and/or mobile, and they all use batteries for their operation.

Prior Art Switches

Notwithstanding the switch, there is a recurring theme. There is a power source, which no matter how little current is being used, the switch is in a powered up condition. Therefore, whether the switch utilizes batteries or some other power source in connection with batteries like, rechargeable, the assembly is in a powered up condition utilizing power. Such systems possess all the frailties of a battery system. For example batteries die at inopportune times and rechargeable batteries while in abundance, add a cost to any system and may make the difference of marketing a low cost product or not.

There are many remote switches, which are actuated pursuant to various stimuli. For example, some switches are sound activated, while others, are activated by movement or changes in ambient light.

Prior Art of Electrical Generators:

To date the only practical methods employed in generating electrical energy for any discernable amount useable to humankind are: electromagnetic, electrostatic, chemical, solar, piezoelectric, and nuclear. Electromagnetic coil wound constant voltage generators are one type. Electromagnetic transformers, which are passive but can, provide for step-up and step-down performance for enhancing and controlling the electromagnetic coil wound constant voltage generators. Electrostatic generators such as type Van De Graaff generate large amounts of electricity similar to natural lightning. Chemical means by voltaic cells and batteries are of a wide variety, and it is well-known that solar panels made from semi-conductor material may be used to generate electricity. Natural piezoelectric crystals and modern day piezoelectric ceramic material are examples of yet another form to produce electricity. Piezoelectric ceramics are hard, chemically inert and completely insensitive to humidity and atmospheric change. It is well known that a piezoelectric transducer can convert a mechanical force into electrical energy.

Piezoelectric materials may either be crystals or ceramics with a polycrystalline ferromagnetic structure, which is essentially cubic. Upon the application of electricity, the ceramic material deforms. Given the charge alignment of the material, the piezoelectric material deforms uniformly within a region. This deformation is dependent on polarization and when the polarization is reversed so is the direction of deformation. This change is termed “hvsteresis' and simply means that the material deforms in relation to the applied current past a zero point. PZT materials used for high displacement and force, and operate well below their resonant frequencies.

PZT actuators convert electrical signals like voltages into mechanical displacements—based on the amount of displacement (small=axial and transversal actuators) (large=flexural actuator)—based on stiffness (springiness of material)

While PZT is the preferred material for piezoelectric generators, neodymium magnets are preferred for magnet and coil generators. Neodymium, a rare earth metal is the most popular material for a new generation magnet.

### OBJECTS OF THE INVENTION

It is therefore an object of the invention to provide a remote control electrical switch without using batteries capable of generating electrical energy internal to its embodiment.

It is a further object of the invention to provide an electrical switch means using no batteries or any other external electrical energy source, yet being capable of generating electrical energy internal to its embodiment for the purpose of applying electrical energy to activate and power a micro-electronic circuit, which comprises a radio frequency signal or any other type of signal such as infrared or optical or ultrasound containing some form of intelligent information for a period of time, which will propagate through space and be remotely received by a radio frequency receiver or any other type of receiver such as infrared or optical or ultrasound for the purpose of executing some useful function such as activating lighting fixtures or appliances or any other remotely located system, without the use or need of wires or batteries or any other external electrical energy source. All of these mentioned components being germane and internal to the electrical switch embodiment.

It is a further object of the invention to provide an electrical switch, which is remote and portable.

It is a further object of the invention to provide an electrical switch means using no batteries or any other external electrical energy source, yet being capable of generating electrical energy internal to its embodiment by a combination of an electromagnetic means, enhanced electromagnetic, a piezoelectric means, and any chemical means, or any photon power cell or cells generation means, which is capable of generating electricity to activate and power a micro-electronic circuit, which comprises a radio frequency signal or any other type of signal such as infrared or optical or ultrasound containing some form of intelligent information for a period of time, which will propagate through space and be remotely received by a radio frequency receiver or any other type of receiver such as infrared or optical or ultrasound for the purpose of executing some useful function such as activating lighting fixtures or appliances or any other remotely located system, without the use or need of wires or batteries or any other external electrical energy source.

It is a further object of the invention to provide an electrical switch means using no batteries or any other external electrical energy source, yet being capable of where said non-battery energy means is enhanced and sustained or stored for a period of time after said non-battery means said method of storage is accomplished by a carbon aerogel supercapacitor or a plurality of supercapacitors.

It is a further object of the invention to provide an electrical energy source means using no batteries or any other external electrical energy source, yet being capable of generating electrical energy internal to its embodiment by an electromagnetic means or enhanced electromagnetic means. Where said non-battery energy means is enhanced and sustained or stored for a period of time after said non-battery means is non-operational either by intention or malfunction. Said method of storage is accomplished by a carbon aerogel supercapacitor or a plurality of supercapacitors.

### SUMMARY OF THE INVENTION

This particular invention relates to generating electrical energy without battery means, and further this generation means being portable and remote. By the establishment of a circuitous arrangement of micro-electronic components and software with purpose of generating a radio frequency signal or any other type of signal such as infrared or optical or ultrasound containing some form of intelligent information for a period of time, which will propagate through space and be remotely received by a radio frequency receiver or any other type of receiver such as infrared or optical or ultrasound for the purpose of executing some useful function such as activating lighting fixtures or appliances or any other remotely located system, without the use or need of wires or batteries or any other external electrical energy source.

An actuation means like a switch or button enervates an energy generating means to produce a voltage. The voltage is transmitted to a capacitor that momentarily stores the electricity so that it is of a desired voltage and wattage. From the capacitor, the voltage travels to a transmitter that sends an encoded signal to the decoder in the receiver. The transmitter may be omni-directional in its transmission of radio waves, and the transmitter must be addressable. From the receiver, the received signal activates a relay driver circuit capable of turning on an electrical relay, which remains on (turning an appliance or light on) until a new received signals turns the relay off.

### BRIEF DESCRIPTION OF THE DRAWINGS

It should be understood, by one skilled in the art, that the drawings depict certain embodiments of the invention and therefore are not to be considered a limitation in the scope of the instant invention, but that these and other advantages of the present invention will be more fully understood by reference to the following detailed description when read in conjunction with the attached drawings in which:

FIG. 1 is a side elevational view in perspective depicting a self-contained remote switch utilizing a coil and magnet;

FIG. 2 is a front view thereof;

FIG. 3 is a side, plan view, actuation thereof;

FIG. 3A is a side plan view and diagram thereof;

FIG. 4 is a side plan view showing a piezoelectric power source thereof;

FIG. 5 is a side plan view showing another piezoelectric power source thereof;

FIG. 6 is a side plan view showing yet another piezoelectric power source thereof;

FIG. 7 is side plan view showing actuation of a piezoelectric power source;

FIG. 8 is side plan view showing actuation of the piezoelectric power source and diagram thereof; and

FIG. 9 is a diagrammatic view of a flow chart showing the electronics for a self-contained remote switch.

### DETAILED DESCRIPTION OF THE PREFERRED EMBODIMENT

To wit, turning now with more specificity to the drawings, wherein like numerals refer to like parts throughout, the numeral 12 appertains generally to a self-contained remote switch. It should be noted, that for purposes of the instant invention, the self-contained remote switch will be described in terms of either a magnet and coil or piezoelectric electrical generator, both being interchangeable for purposes of disclosing the instant invention.

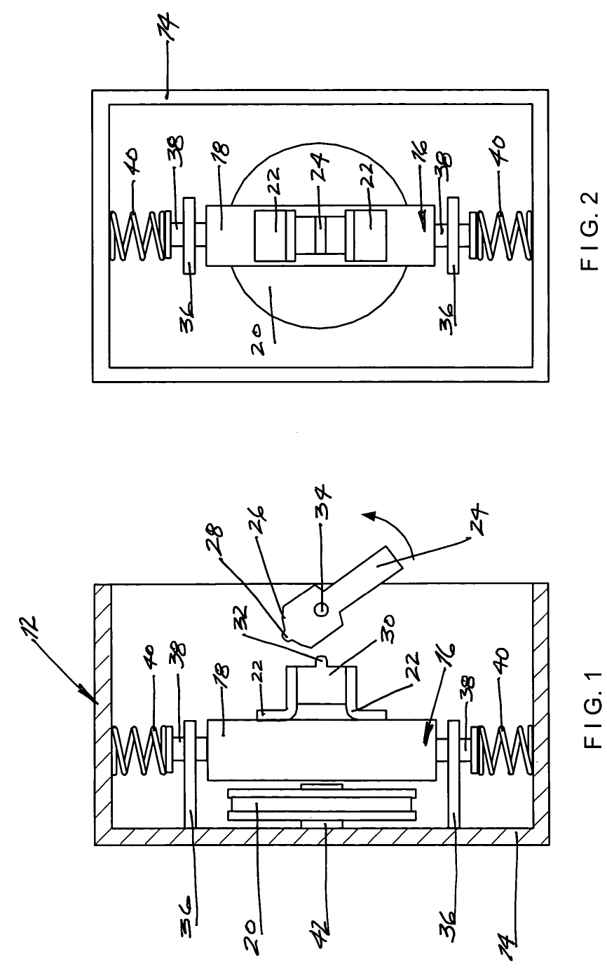

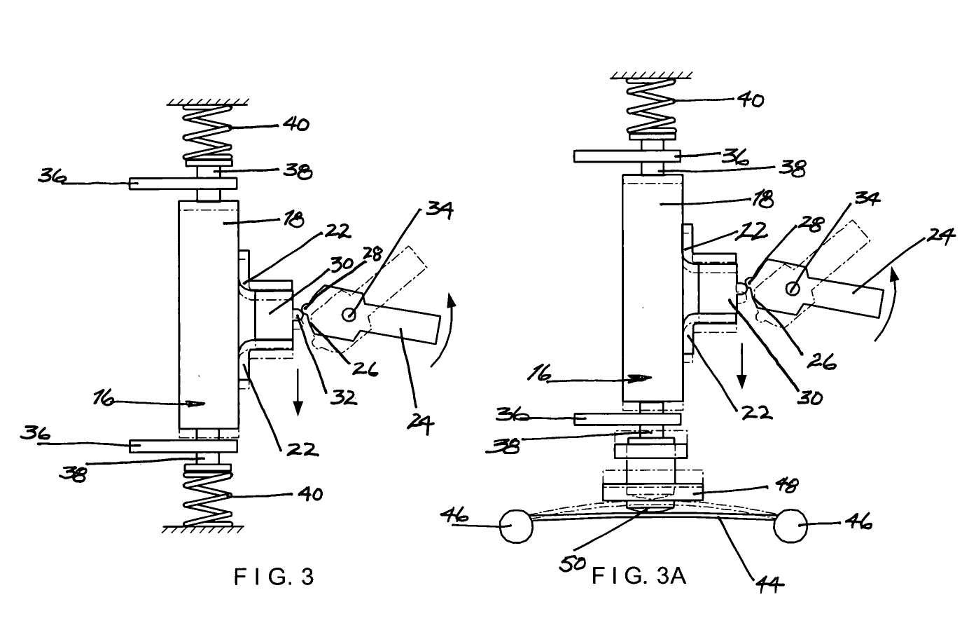

FIGS. 1 and 2 show self-contained remote switch 12 in an embodiment utilizing an energy generating means 16 of a magnet and coil embodiment. To the user self-contained remote switch 12 mirrors the characteristics of a single pole toggle switch, and for all intents and purposes retrofits such a switch. The assembly includes a handle of lever 24, an axial pin 34 to allow said lever 24 to move up and down, along a rounded area 26, to an outstanding engagement nub 28. Outstanding engagement nub 28 contacts actuation nub 32 and the resultant movement of lever 24 causes nubs 28 and 32 to momentarily come in immovable contact and then pass, transferring mechanical energy to power generating means 16. Actuation nub 32 is integral to block 30 and held immovably by L-shaped brackets 22, said L-shaped brackets being immovably retained on power generating means 16. And in accordance with FIGS. 3 and 3a spring or springs 40 are alternately compressed and released so as to convert the mechanical energy of the snap of lever 24 and nubs 28 and 32 to release the stored mechanical energy of spring(s) 40, which in turn is converted to electrical energy. As can be clearly seen in FIGS. 3 and 3A, this takes place as a byproduct of magnet 18 passing over coil 20 (of FIG. 1), or as a result of plunger 54 deforming piezoelectric actuator 44 of FIG. 3A.

FIGS. 3 and 3A show self-contained remote switch 12 in an actuated mode. If a user flips lever 24 upwards spring(s) 40 is alternately compressed and then released so that there is a series of movements, which is damped and oscillatory in its nature.

Turning to FIGS. 1, 2, 3, and 3A power generating means 16 can be either electromagnetic or piezoelectric. For an embodiment, which is electromagnetic, power generating means 16 would be constructed from a magnet 18 held by attachment to piston 38 which resides within guides 36 and is in communication with spring(s) 40. It is through compression and release of springs 40 as described hereinabove, that mechanical energy is used to pass magnet 18 over coil 20, thereby inducing an electromotive force in coil 20. In an embodiment, which is piezoelectric (FIG. 3A), power generating means 16 would be constructed from a piezoelectric actuator 44, which is deformed by rounded portion 50 of plunger 48, said plunger being in operative communication with piston 38 through guides 36 and spring 40. It is through deformation of the piezoelectric actuator 44 that mechanical distortion of the piezoelectric yield a resultant electrical moment. In FIGS. 3A, 5 and 6 piezoelectric actuator(s) 44 are secured to housing 14 by actuator attachments 46.

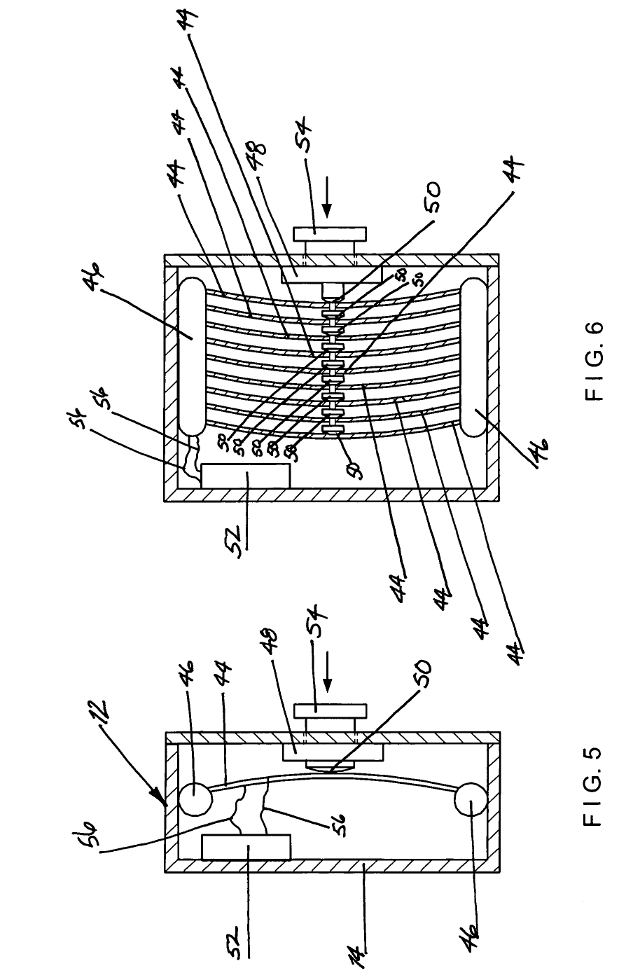

FIGS. 5 and 6 show alternate embodiments where self-contained remote switch 12 utilizes a power generating means 16, positioned within housing 14, where there is a single piezoelectric actuator 44 as in FIG. 5 and a plurality of piezoelectric transducers 44 as in FIG. 6. It should be noted that the plurality of piezoelectric transducers 44 not only yields a substantially greater amount of energy, but also requires a pushbutton type actuator 54. Normally the plurality is wired in parallel, and would generate an additive power effect. Wires 56 provide an electrical conduit from the piezoelectric actuator 44 to circuit board 52.

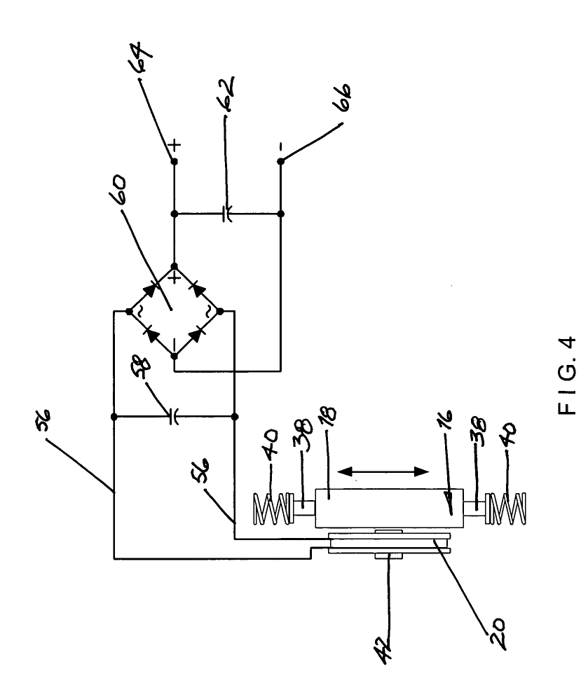

FIG. 4 best illustrates by diagram that when magnet 18 passes over coil 20, by virtue of the release of springs 40, that the resulting voltage passes through electrical conduit 56 to a transient capacitor 58 and then to bridge rectifier 60. From bridge rectifier 60 the voltage is stored within super capacitor 62. The current which was AC prior to bridge rectifier 60 becomes pulsating DC current after its travel through bridge rectifier 60 and is stored and held as filtered DC which appears as a constant DC voltage for a fixed period of time across positive terminal 64 and negative terminal 66.

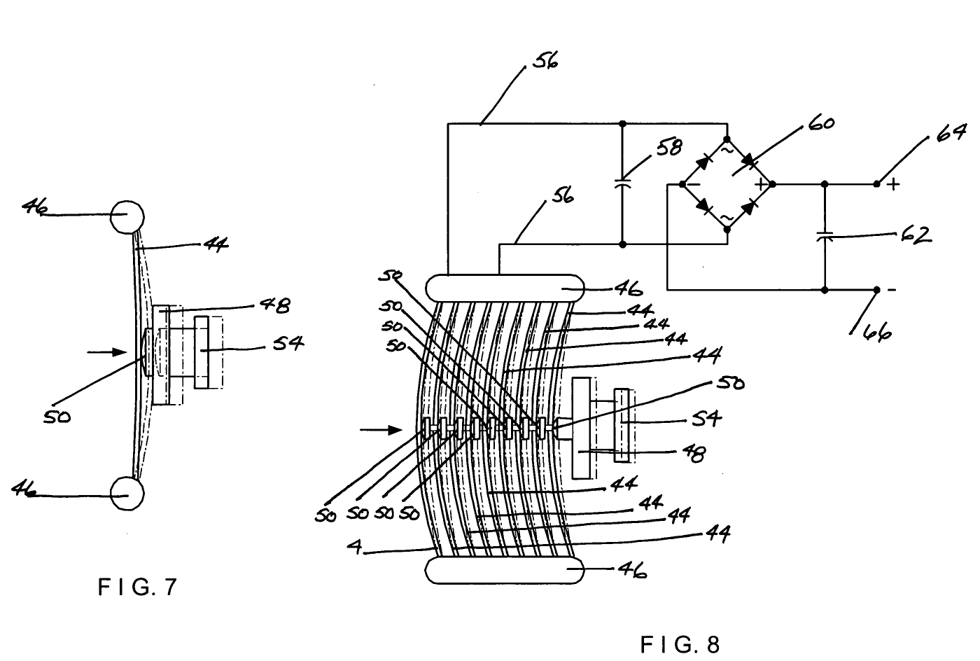

FIGS. 7 and 8, show alternate embodiments where there is a single piezoelectric actuator 44 or a plurality of piezoelectric actuators 44 in a cascaded array. With reference to FIG. 8, a plurality of piezoelectric actuators 44 are cascaded as are the plungers 48 so that the piezoelectric actuators move simultaneously to maximize the electrical moment and increase the output of power. By depressing pushbutton 54, and thereby deforming piezoelectric actuators 44, the resulting voltage passes through electrical conduit 56 to a transient capacitor 58 and then to bridge rectifier 60. From bridge rectifier 60 the voltage is stored within super capacitor 62. The current which was AC prior to bridge rectifier 60 becomes pulsating DC current after its travel through bridge rectifier 60 and is stored and held as filtered DC which appears as a constant DC voltage for a fixed period of time across positive terminal 64 and negative terminal 66.

As a general rule it is preferred, notwithstanding the type of power generation means 16 that the system generates from about 1 milliamp to about 100 milliamps for a period of from about 60 milliseconds to about 200 milliseconds, so that the effective voltage is from about 1.6 volts to about 4 volts DC. It is most preferred that the system generates 3.3 volts at 5 milliamps at 100 milliseconds.

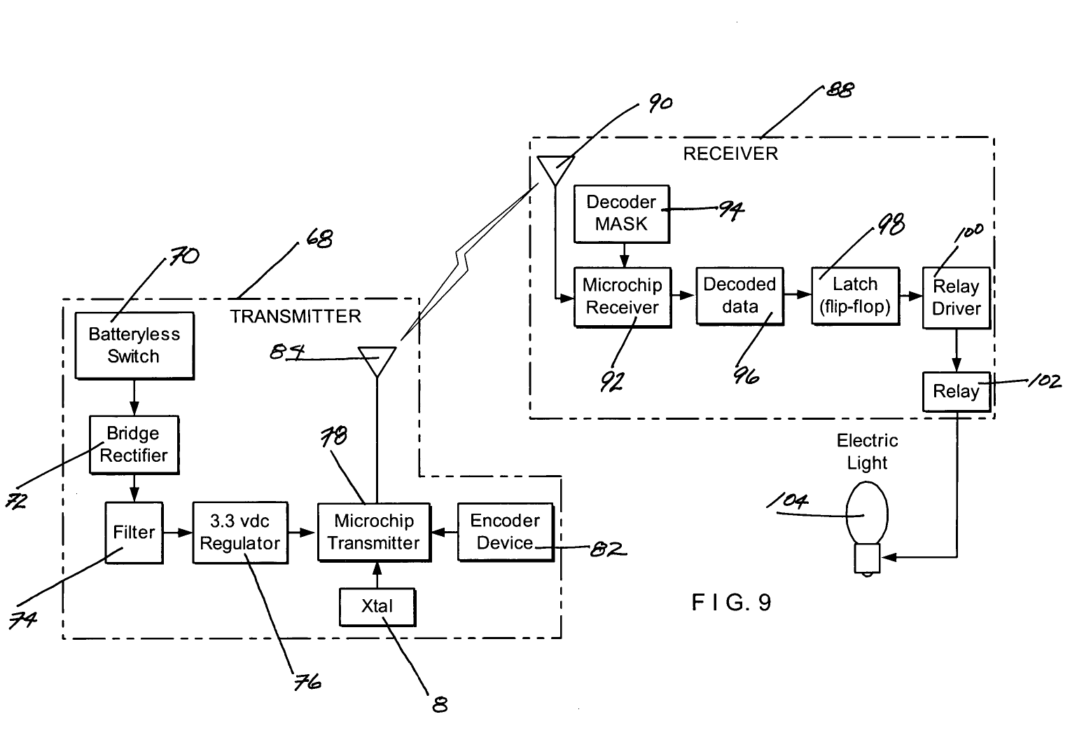

FIG. 9 is a diagrammatic view showing a flowchart or block diagram of self-contained switch 12 wherein transmitter unit 68 (delineated by dotted lines and representing a transportable remote self-contained switch) communicates with receiver 88 (delineated by dotted lines and representing a hardwired electric light/appliance). Within transmitter unit 68 resides an embodiment of self-contained switch 12 and termed switch 70 (which includes a housing 14, power generating means 16, springs 40, L-shaped brackets 22, switch lever 24, rounded section 26, engagement nub 28, block 30, actuation nub 32, axial pin 34, guide 36, attachment 38, threaded metallic high permeability core 42, pushbutton 54, at least a pair of rigid support rods 46, plunger 48, circuit board 52 wires 56 of FIGS. 1-5). Switch 70 generates an AC voltage, which is changed to pulsating DC current by bridge rectifier 73 and converted to a constant DC voltage by filter (capacitor) 74 and is regulated to the preferred voltage of about 3.3 volts by voltage regulator 76, providing optimal operating power to microchip transmitter 78, which in turn has its transmitted frequency determined by crystal 80. Encoder device 82 provides digitally encoded data to microchip transmitter 78 for selective actions pursuant to decoding. This digitally encoded data is transmitted by transmitter antenna 84 and received by receiver antenna 90 of receiver 88 and this received encoded signal flows to microchip receiver 92. The encoded signal is compared to the decoder mask 94, and if the encoded received signal is the same as the decoder mask 94 it will be established as valid decoded data 96, and will provide a valid logic one output latch flip flop 98. The output of latch flip flop 98 turns on relay driver 100, and relay driver 100 remains on to keep electrical relay 102 in an enabled condition. The enabled condition of relay 102 completes an electrical circuit, which turns on electric light or appliance 104.

There are a number of pre-sets, which allow self-contained remote switch 12 to remain in an off or no power condition. The pre-sets include that the transmitter is constantly enabled.

As a general precept the prior art as described hereinabove, requires that the wireless remote system be in a powered up condition. That is a condition where a battery or other power source provides a continuous infusion of electricity. No matter how low the power requirement is, there is power being supplied to the assemblage so that when the user actuates the on/off switch additional power is transmitted to the disparate parts. The instant invention utilizes an assembly where there is no ambient power, but a series of pre-sets so that when power is generated and transmitted to the instant assemblage the switch can then function as designed.

Chip Configurations

The Texas Instruments TRF6900 transceiver or the TRF 4900 transmitter consumes low amount of electrical energy. Its supply voltage range is from 2.2 to 3.6 volts. It draws on the average, 26 milli-amps of current at 3.3 volts. This represents an operational power consumption of only 85 milli-watts. Other parameters of interest are: It has a sleep mode, which only draws 5 micro-amps of power and can be activated within 500 micro-seconds. Its frequency hopping time is only 30 micro-seconds and data transmission rates are of 115 kilobits per second (kbps). It can be used in either linear (FM) or digital (FSK) modulated applications.

It is this device's low power consumption, which leads to a novel conclusion in that the present invention teaches that such a device can be made fully operational by eliminating a battery (used for continuous operation) and in its stead using either an electromagnetic means, or piezoelectric means of supplying power long enough to send a short burst of useful information over short distances for a variety of useful purposes.

Electromagnetic Means

Faraday's Law states that any change in the magnetic environment of a coil of wire will cause a voltage or electromotive force (emf) to be “induced” in the coil. No matter how the change is produced, said voltage will be generated. The change could be produced by changing the magnetic field strength, moving a magnet toward or away from the coil, moving the coil into or out of the magnetic field, and rotating the coil relative to the magnet.

A voltage or electromotive force can be generated across a coil or solenoid by moving a magnet toward or away from a coil or solenoid of wire. With the area constant, the changing magnetic field causes a voltage to the generated. The direction or “sense” of the voltage generated in said coil or solenoid is such that any resulting current produces a magnetic field opposing the change in magnetic field, which created it.

It is now possible, using supermagnets composed of Neodymium a rare earth material, to design a momentary electrical energy generator, which will generate sufficient electrical energy to power a micro-chip transmitter or transceiver module and transmit enough data during said generation time to activate a remote receiving unit and perform a useful function. The momentary electrical energy generator in its broadest form is simply comprised of a coil of wire and a supermagnet.

When the magnet is moved over the coil, it generates a voltage at the end terminals of said coil. In another embodiment of a momentary generator, the configuration may best be described as it is similar to a snap action spring switch. When the toggle is thrown springs create a snap action quality, which within a housing, a coil resides and a magnet supported by guides, and passing over the core of the coil. As the magnet moves, its magnetic field cuts through the coil wire and by Faraday's Law generates a voltage, which is applied to the circuitry. This series of events produces the momentary operation of the present invention.

Piezoelectric Means

Crystals and certain poly-ceramic materials such as PZT (lead zirconate titanate), which acquire a charge when compressed, twisted or distorted are said to be piezoelectric. Therefore it is realized that a piezoelectric material produces a voltage, which is of sufficient quantity to provide a momentary source of power to activate a micro-chip transmitter module. For example and by illustration, there is a switch configuration where a piezoelectric element gas igniter device or an igniter used in cigarette lighters. When the igniter button is depressed a spring action trigger causes the igniter to generate a voltage activating the circuitry.

Another piezoelectric means for generating momentary power to activate a micro-chip transmitter module is a piezoelectric unimorph actuator of which there are many varieties considered functional for the present invention. This is a flat plate arrangement of a piezoelectric element as shown in. When push button is depressed springs allow for the flat plate piezoelectric actuator to move and generate a voltage, which energizes the circuitry. Housing can either be mounted on a wall or left free to move form place to place like a typical remote control.

Any of these piezoelectric arrangements then, are capable of momentary activation, which will generate sufficient electrical energy to power a micro-chip transmitter or transceiver module and transmit enough data during said generation time to activate a remote receiving unit and perform a useful function. It is important to realize that the amount of useful electrical energy generated is directly proportional the time derivative of mechanical striking force imparted to said piezoelectric element.

Supercapacitor Enhancement

Energy storage devices may be broadly characterized by their energy density (energy stored per unit volume or mass) and by their power (how fast that energy can be delivered from the device).

At one end of the scale, conventional capacitors have enormous power but store only tiny amounts of energy. At the other end, batteries can store lots of energy but take a long time to be charged up or discharge. That is they have low power. Relative to these established technologies, supercapacitors offer a unique combination of high power and high-energy performance parameters with commercial relevance.

Batteries are ‘charged’ when they undergo an internal chemical reaction under a potential applied to the terminals. They deliver the absorbed energy, or ‘discharge’, when they reverse the chemical reaction. In contrast, when a supercapacitor is charged there is no chemical reaction. The energy is stored as a charge or concentration of electrons on the surface of a material.

This difference in principle of operation is the key to the difference in behavior and contrasting benefits of the two broad types of energy storage device.

For many years batteries have been the preferred storage device for most applications because of their superior capability to store energy (i.e. high energy density). The amount of energy, measured in Joules, watt hours or amp hours, that can be stored has been sufficiently high for useful batteries to have been made and sold for all of this century. Where the application has demanded high power, the battery has been over engineered and the lifetime of the battery compromised. New battery technology such as lithium ion has been developed to increase power and energy storage. Fundamentally, however, they are energy storage devices. As such batteries will always be a poor solution where high power is required.

Capacitors are electronic devices. Conventional capacitors have enormous power but store only tiny amounts of energy. Supercapacitors offer a unique combination of high power and high energy. Supercapacitors are capable of very fast charges and discharges, and apparently are able to go through a large number of cycles without degradation. Supercapacitors are now being used in a number of applications, mostly as low power devices for memory backup purposes. It is expected that as supercapacitors move into other applications, higher and higher power densities will be required. One of these applications is for load leveling in hybrid electric vehicles. Indeed some work has already been undertaken in this area. Another high power application is in telecommunications, where short high power pulses are required. This move to high power will continue, and it is desirable to establish some capacitor specific testing procedures that will enable a valid comparison between different capacitor technologies.

Supercapacitors' main characteristics are:

Very high power output and low energy content

Fast charge and discharge capabilities

Unlimited number of cycles

No specific constraints when recharging

High efficiency

Low maintenance

Small foot-print

Significant self discharge rate, evaluated to 5% per day

Life time averaging 8-10 years

Compared to batteries, supercapacitors can be described as high-power, low-energy, energy storage devices. Supercapacitors are often compared on an energy density basis; however energy density is not a useful comparison under high power conditions.

Power density alone, is also not very informative since it provides no information on the amount of work a capacitor can do.

Ragone plots mathematically compare power density to energy density. Whilst Ragone plots have been used to characterize batteries for many years, capacitors have very different characteristics and their behaviour is not always best described using Ragone plots. One noticeable difference is that the power capability of a supercapacitor depends on its state of charge, in contrast to batteries.

Another is that capacitors may be required to be charged, as well as discharged, at high power. An alternative test for capacitor capability, called a power capability chart, (PCC), which combines energy and power density and provides a tool for clear discrimination between supercapacitors of different characteristics.

A traditional Ragone plot describes the relationship between energy and power, generally with the assumption of the capacitor voltage dropping to V/2 (ie using three quarters of the energy), and power delivered into a matched load (load resistance equal to capacitor esr). The energy dissipated in the capacitor depends on the current, and so also on the power level. In many applications however, the load resistance will change depending on the power required, and in many circumstances constant power delivery is required

The behavior of an ideal capacitor under constant power charge and discharge can be calculated.

The basic equations are:

$$\begin{matrix}Q = CE \\ V = E - i {R}_{esr} \\ {P}_{de1} = i V \\ i = - \frac{ⅆ Q}{ⅆ t}\end{matrix}$$

where C is capacitance in Farads, E is the capacitor emf, V is the terminal voltage of the capacitor, i is the current, P_{del} is the power delivered to the load and Q is the capacitor charge at time t. Using the DC time constant, t_{c}=CRₑₛᵣ, these equations can be rearranged to

$$\frac{ⅆ Q}{ⅆ t} = \frac{1}{2 {τ}_{c}} [ {( {Q}^{2} - 4 {C}_{{τ}_{c}} {P}_{del} )}^{\frac{1}{2}} - Q ]$$

The solution to this equation, given an initial charge Q, provides Q at time t, which then allows calculation of i, E and V. When

Q²=4Cτ_{c}P_{del}

there is insufficient charge to provide P_{del} and this time is referred to as the breakpoint. The charge remaining in the capacitor from this point onwards can be calculated using

$$\frac{ⅆ Q}{ⅆ t} = - \frac{Q}{2 {τ}_{c}}$$

Therefore the present invention utilizes a configuration of a battery-less generator enhanced with a supercapacitor or a plurality of supercapacitors to establish a battery-less, human powered generator for emergency use. Human powered from the point of any motion caused by a human being (doing) inputting energy into one of the present invention's above mentioned methods of generating momentary electrical energy. This could be used to operate low powered appliances such as radios, cell phones, lap-top computers, emergency lighting, etc. FIG. 5 shows a schematic diagram of a full wave bridge rectifier power supply system incorporating a supercapacitor as a filter charge system. Electrical energy is supplied by a human powered generator and is first pre-filtered by a small value capacitor to transient protect the bridge rectifier system.

Another embodiment of the present invention FIG. 5 is an inertial type electromagnetic generator, which has a supermagnet enclosed in a cylinder and suspended by springs. Any motion causes the supermagnet to oscillate and its magnetic line of force cut through the coil, which by Faraday's Law induces a voltage across the coil terminals. This action is present whenever any motion occurs. Whenever any motion of any kind presents itself, electrical energy will be generated and stored in the supercapacitor. This application of the present invention may be applied to humans for proper operation, or to any vehicle capable of motion for proper operation.

FIG. 9 is an additional adaptation of the present invention, where an array of piezoelectric unimorph plates in an enclosure and connected so as to increase the overall power output. The plates are held in support within said enclosure and their centres are connected to a mechanical load. The mechanical load causes the plates to oscillate in conjunction with any motion. In essence, they behave in similar operation mechanically as does the previous electromagnetic configuration as described above and shown in FIG. 5. This action is present whenever any motion occurs. Whenever any motion of any kind presents itself, electrical energy will be generated and stored in the supercapacitor. This application of the present invention may be applied to humans for proper operation, or to any vehicle capable of motion for proper operation.

Filtering and Voltage Regulation

The present invention teaches that whether an electromagnetic means or a piezoelectric means is used to provide momentary activation of said micro-chip transmitter or transceiver module, the voltage produced will have varying amplitudes over a time period deemed useful in amplitude for chip activation. Therefore it is vital to insure that the voltage generated is filtered and then regulated so as to provide a reliable and repeatable period of activation. Waveshape analysis is an important design feature in this instance. State of art micro-chip transmitter and transceiver modules have a minimum operational level of 1.6 volts dc and a maximum operational level of 3.6 volts dc. A trade off in voltage level versus performance and power drain is the critical design consideration, which must be acknowledged. Ergo, a safe range of operation is from 2.2 to 3.3 volts dc for this technology. It is important to maintain this operational voltage range for reliability as well as providing the most effective omni-directional characteristic of the radiated wave pattern.

Configured Variations

One application for the present invention, which also is its broadest configuration, is to be utilized as a remote electrical switch. Whichever approach is incorporated for the power generation, either electromagnetic or piezoelectric, once the battery-less, embodiment activates the micro-electronic transmitter or transceiver a signal is sent for a finite period of time and is received by a receiver at some wireless remote location. A typical arrangement is shown in a block diagram described hereinabove. The transmitter gets it activation power from the battery-less switch, where the alternating voltage is rectified by the bridge rectifier and then filtered by filter, which provides a steady dc voltage level. This voltage level is greater than that required by the microchip transmitter so it must be regulated and reduced to 3.3 volts dc by the 3.3 volt dc regulator. The transmitter chip generates a signal whose frequency is determined by crystal. Any data is pre-encoded within the data chip and control the transmitted FSK output of said transmitter. This signal is radiated into space by the built in antenna.

A micro-chip transceiver or receiver chip located remotely and wireless from said transmitter switch device of said present invention. It receives the transmitted signal by then antenna this received data is decoded in the micro-chip receiver and information causes relay driver to turn on, which triggers a latch relay. Latch relay remains activated to keep on a light or some other electrical device. When a second signal is transmitted, the latch relay now turns the light or other device off.

Consider a wall mounted conventional switch and home lighting circuit. Power is connected into a home and distributed throughout the household. Wires connect the wall switch to a light in the ceiling of a room and operate as a wired electrical circuit. The present invention teaches that if it were in use, wiring running from switch to light in ceiling would be eliminated. In fact it would not even be necessary to mount the switch in the wall. The present invention used in this manner needs no mounting or cutting through walls, etc. It can be held in position on a wall by a slot or sleeve to be removed and carried if so desired. It by definition is a remote switch with no wires connected externally to any device, light or otherwise. It uses no batteries, yet performs a useful function. That function being defined as the switching on and off of a light device. A wireless and battery-less “door bell” type announcer in apartment buildings and large institutions is an additional use.

These and many other applications are made possible through another enhancement of the present invention. In its broadest sense, the present invention uses a micro-chip transmitter module, like that of Texas Instruments TRF4900, to send a signal to a remote receiver. If the present invention were to incorporate a micro-chip transceiver module, like that of Texas Instruments TRF6900, to send a signal to a remote transceiver, like that of Texas Instruments TRF6900, then the present invention teaches that security and identification and verification is available from the present invention. This enhanced system functions as follows: Once triggered, the wireless and battery-less security switch is capable of sending a momentary signal for a period of time designated by design parameters of the momentary or pulsed electromagnetic or piezoelectric electrical energy source. The duration of transmitted data is determined by how long electrical energy is present at a threshold of minimum amplitude from the time the switch is activated until said electrical energy falls below the threshold. This period, in all actuality, is the useable or working threshold amplitude necessary to power said micro-chip transmitter or transceiver module and maintain a constant omni-directional range of operation. The useable time range (delta t) is as compared to a set threshold level of 2 volts dc may be represented in a graph. This useable time range from experimental data is in a range of 20 to 75 milliseconds. The TRF6900 RF transceiver-on-a-chip when used in the FSK (digital) modulated mode supports a typical data transmission rate of 115 kilobits per second (kbps). Therefore 20 to 75 milliseconds allow a data transfer rate of 2.3 to 8.625 kilobits of data to be transmitted during the useable time period. This is enough data to relay a significant amount of information.

For security applications a wireless and battery-less transmit/receive ID verifications system is another novelty of the present invention. The ID verification system operation functions as a circuitous data link. Embedded personal ID information in the “battery-less” transceiver is sent to a central computer system where the data is analyzed and interrogated. If the person in question is a valid employee or seen as a friend versus a foe, then the central computer sends back to the “battery-less” remote transceiver a verification code. After the “battery-less” remote transceiver receives the information, it then sends a key code back to central computer, whereby the computer provides some form of entry or clearance. Every time the “battery-less” remote transceiver sends a “new signal”; the central computer issues a new key code. This eliminates any chance for failure, deception or breach of security. The “new signal” is based on a principle, which is another feature of the present invention.

While the foregoing embodiments of the invention have been set forth in considerable detail for the purposes of making a complete disclosure of the invention, it will be apparent to those of skill in the art that numerous changes may be made in such details without departing from the spirit and the principles of the invention.

I claim:

1. A self-contained switch comprising:
a housing;
an actuation means adapted to initiate a physical movement of;
a power generating means capable of generating a voltage from physically moving said actuation means, and translating said physical movement into an electrical moment, said power generating means in operative communication with;
a transmitter to transmit a signal such that said signal is addressed, so that said signal is unique and wherein said means for transmitting a signal being in operative communication with;
a means for receiving said signal and a series of programmed instructions from said signal from said transmitting means to be received by said receiving means and effective to direct an operation; and
a protocol for employing said series of instructions received by said receiving means effective to complete an operation.

2. A self-contained switch comprising:
a housing;
an actuation means adapted to initiate a physical movement of;
a power generating means capable of generating a voltage from physically moving said actuation means, and translating said physical movement into an electrical moment, said power generating means in operative communication with;
a rectifier;
a filter in communication with a voltage regulator;
a microchip transmitter containing encoded data and enabled to transmit encoded data through an antennae to a remote antenna, by virtue of a crystal that provides a specific frequency for the transmission of said data, said remote antenna in communication with a microchip receiver, said microchip receiver containing a decoder mask to decode the encoded data received by said receiver to activate a latch and to communicate with a relay driver, said relay driver being in communication with a relay which in turn is in operative communication with an end appliance and a power source.

3. A power generating means as described in claim 1 further comprising:
a housing;
a piezoelectric actuator;
at least a pair of wires in communication with said piezoelectric actuator;
at least a pair of rigid support rods to hold the piezoelectric actuator within said housing; and
a plunger to deform the piezoelectric actuator and create a voltage.

4. A power generating means as described in claim 1 further comprising a plurality of piezoelectric actuators.

5. A power generating means as described in claim 1 further comprising:
a housing;
a magnet placed above a coil so that said magnet is drawn across said coil;
at least a pair of wires in communication with said coil;
a threaded metallic high magnet permeability core to hold said coil and magnet within said housing; and
a lever to encourage an outstanding nub to engage an actuation nub so that said magnet which is attached to at least two springs moves back and forth over said coil to produce a voltage.

6. A magnet as described in claim 5 further comprising a neodymium magnet.

7. A self-contained remote switch as described in claim 1 further comprising:
an electrical conduit to send a voltage from a power generating means to;
a transient capacitor and to a bridge rectifier to convert AC to pulsating DC current and to send said voltage to;
a supercapacitor for storing said voltage prior to utilizing said voltage by; and
a transmitter, said transmitter to send addressed data to a receiver, said receiver utilizing said data to perform an operation.

8. A supercapacitor as described in claim 7 further comprising a carbon aerogel supercapacitor.

9. A voltage as described in claim 7 further comprising a voltage from about 1 milliamp to about 100 milliamps and from about 1.6 volts to about 4 volts.

10. A voltage as described in claim 7 further comprising a voltage of about 3.3 volts.

11. A transmitter and a receiver as described in claim 7 further comprising encoded and decoded data.

12. A transmitter and a receiver as described in claim 7 further comprising a transceiver chip.

13. An actuation means as described in claim 1 further comprising a switch lever or a push button.

14. A remote self-contained switch as described in claim 1 that is in a power off state.
